(19) United States
(12) Patent Application Publication
(10) Pub. No.: US 2012/0215383 A1
(43) Pub. Date: Aug. 23, 2012

(54) SECURITY CONTROL APPARATUS, TRACK SECURITY APPARATUS, AUTONOMOUS MOBILE ROBOT APPARATUS, AND SECURITY CONTROL SERVICE SYSTEM AND METHOD

(75) Inventors: Ho sub YOON, Daejeon (KR); Jae Yeon LEE, Daejeon (KR); Do-Hyung KIM, Daejeon (KR); Hye Jin KIM, Daejeon (KR); Kyu Dae BAN, Daejeon (KR); Youngwoo YOON, Daejeon (KR); Woo-han YUN, Daejeon (KR); Jae Hong KIM, Daejeon (KR); Joo Chan SOHN, Daejeon (KR); Heesung CHAE, Daejeon (KR)

(73) Assignee: Electronics and Telecommunications Research Institute, Daejeon (KR)

(21) Appl. No.: 13/403,345

(22) Filed: Feb. 23, 2012

(30) Foreign Application Priority Data
Feb. 23, 2011 (KR) 10-2011-0016135

(51) Int. Cl. G06F 7/00

(52) U.S. Cl. 701/2; 901/1

(57) ABSTRACT

A security control service system includes: a track security apparatus for traveling along a track installed in a place to be secured, and obtaining and transmitting security information to a security control apparatus; an autonomous mobile robot apparatus for traveling along the track together with the track security apparatus or freely traveling in the place to be secured, and obtaining and transmitting security information to the security control apparatus; and the security control apparatus for transmitting a control command for security control to the track security apparatus or the autonomous mobile robot apparatus after analyzing the security information.

### CROSS-REFERENCE(S) TO RELATED APPLICATION(S)

The present invention claims priority of Korean Patent Application No. 10-2011-0016135, filed on Feb. 23, 2011 which is incorporated herein by references.

### FIELD OF THE INVENTION

The present invention relates to security control, and more particularly, to a track security apparatus that can move along a track installed in a place to be secured, an autonomous mobile robot apparatus that can freely travel, a security control apparatus that remotely controls them to perform security control, a security control service system including the above apparatuses, and a security control service method.

### BACKGROUND OF THE INVENTION

As well-known in the art, a manned or unmanned security control system is established in a place that requires a high level of security, such as a building, a factory, a laboratory, a military camp and the like.

As an example of such a security control system, in a closed circuit television (CCTV) system, a camera is installed in a vulnerable point such as a road or the like to acquire and record a peripheral image. In this system, however, since system establishing cost is relatively high and the resolution, angle of view of the camera and the like are limited, only a limited space may be monitored.

Recently, with the development of a robot automation technique, a security control robot that can freely travel is also used for the security control system.

However, it is difficult for the conventional security control robot to perform a security control function on a wide region due to limit on locomotivity in a complex road environment such as an environment where stairs and obstacles exist in a traveling road or the like.

### SUMMARY OF THE INVENTION

In view of the above, the present invention provides a track security apparatus capable of moving along the track installed in a place to be secured, an autonomous mobile robot apparatus capable of moving while being mounted in the track security apparatus or freely traveling while being separated therefrom, a security control apparatus for remotely controlling the above apparatuses to perform security control, a security control service system including the same, and a security control service method.

In accordance with an aspect of the present invention, there is provided a security control apparatus including: a control command input unit for receiving a control command on a place to be secured; a security information transceiver for transmitting a control command for security control or receiving security information including a peripheral image and a voice through communication with a track security apparatus that obtains the security information while traveling along a track installed in the place to be secured or through communication with an autonomous mobile robot apparatus which obtains the security information including a peripheral image and a voice to transmit the security information while traveling along the track in a state that the autonomous mobile robot apparatus is combined with the track security apparatus or while freely traveling in the place to be secured in a state that the autonomous mobile robot apparatus is separated from the track security apparatus.

The security control apparatus further includes: a security information storage unit for storing the received security information; a security information analysis unit for analyzing the received security information to determine an abnormal situation of the place to be secured, and generating the control command to be transmitted to the track security apparatus or the autonomous mobile robot apparatus through the security information transceiver for combining or separating the autonomous mobile robot apparatus with or from the track security apparatus based on a result of determining the abnormal situation or for performing necessary functions of monitoring, reconnaissance, arrest, emergency situation repress, rescue or repair by the autonomous mobile robot apparatus which has been approached a target position where an abnormal situation occurs; and a security information output unit for outputting information on the determined abnormal situation of the place to be secured.

In accordance with another aspect of the present invention, there is provided a track security apparatus including: a track traveling unit for traveling along a track installed in a place to be secured; a security information acquisition unit for obtaining security information including a peripheral image and a voice depending on traveling of the track traveling unit; a security control transceiver for receiving a control command from a security control apparatus which transmits the control command depending on an input control command for security control or transmitting the security information to the security control apparatus; a security information analysis unit for determining a peripheral abnormal situation of the track by analyzing the security information to transmit the determined abnormal situation to the security control apparatus through the security control transceiver; and a robot attachment/detachment unit combined with or separated from an autonomous mobile robot apparatus depending on the control command information to make the autonomous mobile robot apparatus travel along the track with the track security apparatus or freely travel alone in the place to be secured and obtain the security information including a peripheral image and a voice to determine a peripheral abnormal situation of a traveling position by analyzing the obtained security.

In accordance with still another aspect of the present invention, there is provided: an autonomous mobile robot apparatus including: a free traveling unit for freely traveling separately from a track installed in a place to be secured; a robot attachment/detachment unit combined with or separated from a track security apparatus, which obtains security information including a peripheral image and a voice while traveling along the track, so that the autonomous mobile robot apparatus can travel along the track with the track security apparatus or freely travel alone the place to be secured; a traveling navigation unit for providing information on a traveling path for the free traveling; a security information acquisition unit for obtaining security information including a peripheral image and a voice during the free traveling; a security control transceiver for receiving a control command from a security control apparatus which transmits the control command depending on an input control command for security control or transmitting the security information to the security control apparatus; and a security information analysis unit for determining a peripheral abnormal situation of the traveling path by analyzing the security information so that the determined abnormal situation is transmitted to the security control apparatus through the security control transceiver.

In accordance with still another aspect of the present invention, there is provided a security control service system including: a track security apparatus for traveling along a track installed in a place to be secured, obtaining and transmitting to a security control apparatus security information including a peripheral image and a voice around the track, and detecting a peripheral abnormal situation of the track by analyzing the obtained security information and transmitting the determined abnormal situation to the security control apparatus; and an autonomous mobile robot apparatus for traveling along the track together with the track security apparatus in a state that the autonomous mobile robot apparatus is combined with the track security apparatus and freely traveling in the place to be secured in a state that the autonomous mobile robot apparatus is separated from the track security apparatus, obtaining and transmitting to the security control apparatus security information including a peripheral image and a voice around a traveling path, and detecting a peripheral abnormal situation of a traveling position by analyzing the obtained security information and transmitting the detected abnormal situation to the security control apparatus. The security control service system further includes the security control apparatus for receiving the security information and information on the detected abnormal situation of the track from the track security apparatus or receiving the security information and information on the detected abnormal situation of the traveling position from the autonomous mobile robot apparatus, analyzing the security information received from the track security apparatus or the autonomous mobile robot apparatus to determine an abnormal situation of the track or the traveling position of the autonomous mobile robot apparatus, outputting information on the abnormal situation of the track or the traveling position of the autonomous mobile robot apparatus, and transmitting a control command for security control to the track security apparatus or the autonomous mobile robot apparatus depending on the abnormal situation around the track or around the traveling, or depending on an input control command.

In accordance with still another aspect of the present invention, there is provided a security control service method performed by a security control service system including: obtaining security information including peripheral image and voice while a track security apparatus travels along a track installed in a place to be secured; analyzing, at a security control apparatus that has received the security information, the security information to determine an abnormal situation of the place to be secured; and generating, at the security control apparatus, a control command for security control depending on an abnormal situation of the place to be secured or an input control command.

The method further includes allowing an autonomous mobile robot apparatus to be combined with the track security apparatus to travel along the track, depending on the control command; allowing the autonomous mobile robot apparatus to be separated from the track security apparatus depending on the control command so that the autonomous mobile robot apparatus freely travels to a specific position within the place to be secured; and obtaining, at the autonomous mobile robot apparatus, the security information including image and voice around the specific position and transmitting the security information to the security control apparatus, depending on the control command.

### BRIEF DESCRIPTION OF THE DRAWINGS

The objects and features of the present invention will become apparent from the following description of embodiments, given in conjunction with the accompanying drawings, in which:

FIG. 1 is a block diagram of a security control service system in accordance with an embodiment of the present invention;

FIG. 2 is a detailed block diagram of a security control apparatus in accordance with the embodiment of the present invention;

FIG. 3 is a detailed block diagram of a track security apparatus in accordance with the embodiment of the present invention;

FIG. 4 is a detailed block diagram of an autonomous mobile robot apparatus in accordance with the embodiment of the present invention;

FIG. 5 is a conceptual view illustrating an example in which the security control service system is applied to a parking lot security control system, in accordance with the embodiment of the present invention;

FIG. 6 is a flowchart for explaining an operation process of the track security apparatus in accordance with the embodiment of the present invention;

FIG. 7 is a flowchart for explaining an operation process of the security control apparatus in accordance with the embodiment of the present invention; and

FIG. 8 is a flowchart for explaining an operation process of the autonomous mobile robot apparatus in accordance with the embodiment of the present invention.

### DETAILED DESCRIPTION OF THE EMBODIMENTS

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function(s). In several alternative embodiments, it is noticed that functions described in the blocks or the steps may run out of order. For example, two successive blocks and steps may be substantially executed simultaneously or often in reverse order according to corresponding functions.

Hereinafter, embodiments of the present invention will be described in detail with reference to the accompanying drawings which form a part hereof.

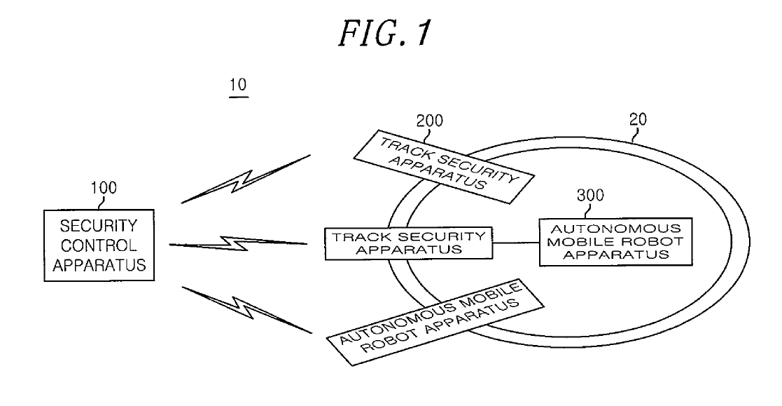

FIG. 1 illustrates a block diagram of a security control service system in accordance with an embodiment of the present invention.

As illustrated in FIG. 1, a security control service system 10 includes a security control apparatus 100, a track security apparatus 200 and an autonomous mobile robot apparatus.

The track security apparatus 200 travels along a track 20 installed in a place to be secured, obtains security information including a peripheral image and a voice to transmit the security information to the security control apparatus 100, and detecting an abnormal situation around the track 20 by analyzing the obtained security information to transmit the detected abnormal situation to the security control apparatus 100. Detailed description of the track security apparatus 200 will be described below with reference to FIG. 3.

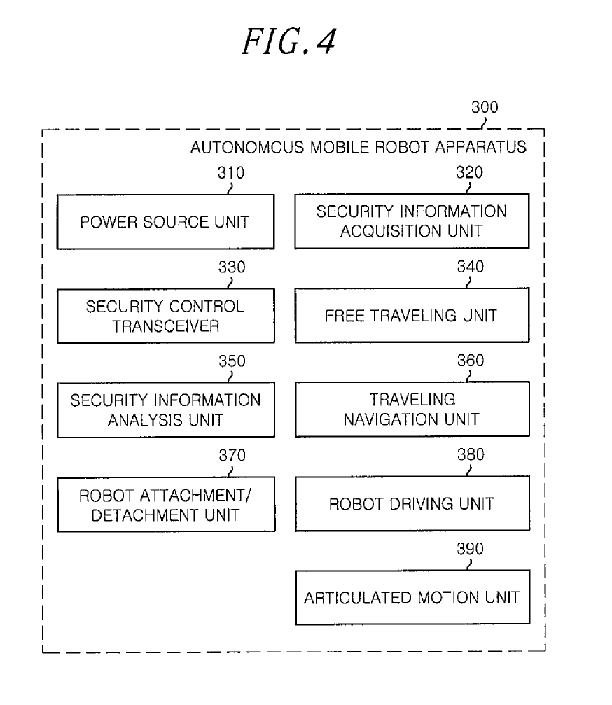

The autonomous mobile robot apparatus 300 travels along the track 20 together with the track security apparatus 200 while being combined therewith or freely travels in the place to be secured while being separated from the track security apparatus 200. Further, the autonomous mobile robot apparatus 300 obtains security information including a peripheral image and a voice to transmit the security information to the security control apparatus 100 and detects an abnormal situation around a traveling position by analyzing the obtained security information to transmit the detected abnormal situation to the security control apparatus 100. Detailed description of the autonomous mobile robot apparatus 300 will be described below with reference to FIG. 4.

Herein, the track security apparatus 200 may function as a wireless access point, and therefore, when the autonomous mobile robot apparatus 300 cannot communicate with the security control apparatus 100 due to a damage of a network or the like, the autonomous mobile robot apparatus 300 transmits the security information to the security control apparatus 100 via the access point of the track security apparatus 200.

The security control apparatus 100 receives the security information and information on the abnormal situation around the track 20 from the track security apparatus 200 or receives the security information and information on the abnormal situation around the traveling position from the autonomous mobile robot apparatus mobile robot apparatus 300. Then, the security control apparatus 100 analyzes the received security information to determine an abnormal situation around the place to be secured, outputs information on the abnormal situation around the track 20, the traveling position of the autonomous mobile robot apparatus 300 or the place to be secured. Then the security control apparatus 100 transmits a control command for security control to the track security apparatus 200 or the autonomous mobile robot apparatus 300 depending on the abnormal situation in the place to be secured including the track 20 or the traveling position of the autonomous mobile robot apparatus 300, or an input control command inputted by an operator.

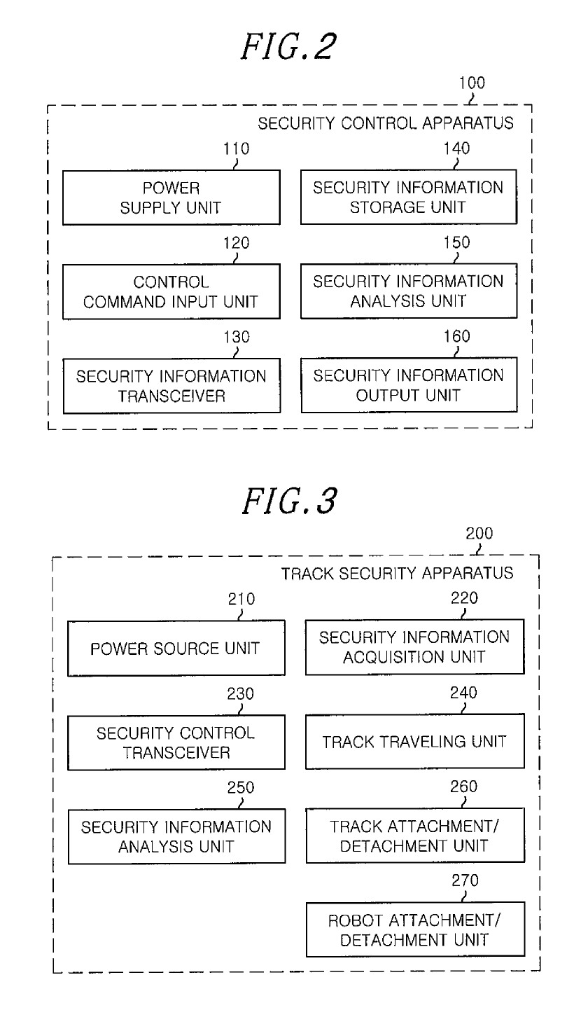

The detailed description of the security control apparatus 100 is now described with reference to FIG. 2. The security control apparatus 100 includes a power supply unit 110, a control command input unit 120, a security information transceiver 130, a security information storage unit 140, a security information analysis unit 150 and a security information output unit 160.

The power supply unit 110 supplies a driving power to the track security apparatus 200 and the autonomous mobile robot apparatus 300 via a power line additionally provided along the path of the track 20 installed in the place to be secured.

The control command input unit 120 receives a control command on the place to be secured from an operator or a separate operating apparatus.

The security information transceiver unit 130 transmits a control command for security control and receives security information through communication with the track security apparatus 200 that travels along the track 20 or the autonomous mobile robot apparatus 300 to obtain the security information including the peripheral image and the voice.

The security information storage unit 140 stores the security information received from the track security apparatus 200 or the security robot apparatus 300.

The security information analysis unit 150 analyzes the received security information to determine an abnormal situation of the place to be secured, and generates a control command to be transmitted to the track security apparatus 200 or the autonomous mobile robot apparatus 300 through the security information transceiver unit 130 for combining or separating the autonomous mobile robot apparatus 300 with or from the track security apparatuses 200 depending on a result of determining the abnormal situation or performing necessary functions of monitoring, reconnaissance, arrest, emergency situation repress, rescue, repair or the like by the autonomous mobile robot apparatus 300 which has been approached a target position where an abnormal situation occurs.

The security information output unit 160 outputs information on the abnormal situation of the place to be secured determined by the security information analyze unit 150.

FIG. 3 illustrates a detailed block diagram of the track security apparatus 200 in accordance with the embodiment of the present invention.

As illustrated in FIG. 3, the track security apparatus 200 includes a power source unit 210, a security information acquisition unit 220, a security control transceiver 230, a track traveling unit 240, a security information analysis unit 250, a track attachment/detachment unit 260 and a robot attachment/detachment unit 270.

The power source unit 210 receives a driving power supplied from the security control apparatus 100 through the power line additionally provided along the path of the track 20 installed in the place to be secured.

The track traveling unit 240 travels along the track 20 installed in the place to be secured.

The security information acquisition unit 220 obtains the security information including the peripheral image and the voice around the track 20 during the traveling of the track traveling unit 240. The security information acquisition unit 220 includes a single or multiple zoom/pan/tilt camera(s) and a single or multiple microphone(s).

The security control transceiver unit 230 transmits or receives a control command or the security information through communication with the security control apparatus 100 that transmits the control command for security control depending on an input control command.

The security information analysis unit 250 detects an abnormal situation around the track by analyzing the security information to transmit the detected abnormal situation to the security control apparatus 100 through the security control transceiver 230.

The track attachment/detachment unit 260 is combined with or separated from the track 20 so that the track security apparatus 200 travels along the track or is positioned around the track.

The robot attachment/detachment unit 270 is combined with or separated from the autonomous mobile robot apparatus 300 depending on the control command so that it can travel along the track 20 with the track security apparatus 200 or freely travel alone.

FIG. 4 illustrates a detailed block diagram of the autonomous mobile robot apparatus 300 in accordance with the embodiment of the present invention.

As illustrated in FIG. 4, the autonomous mobile robot apparatus 300 includes a power source unit 310, a security information acquisition unit 320, a security control transceiver 330, a free traveling unit 340, a security information analysis unit 350, a traveling navigation unit 360, a robot attachment/detachment unit 370, a robot driving unit 380 and an articulated motion unit 390.

The power source unit 310 receives a power supplied from the security control apparatus 100 through a power line additionally provided along the path of the track 20 installed in the place to be secured or receives a power supplied from the track security apparatus 200 to perform charging and to provide a driving power through discharging.

The security information acquisition unit 320 obtains the security information including a peripheral image and a voice around a traveling path during free traveling of the free traveling unit 340. The security information acquisition unit 320 may include a single or multiple zoom/pan/tilt camera(s) and a single or multiple microphone(s).

The security control transceiver 330 receives a control command from the security control apparatus 100 that transmits the control command for security control depending on the input control command or transmits the security information to the security control apparatus.

The free traveling unit 340 freely travels separately from the track 20 installed in the place to be secured.

The security information analysis unit 350 determines an abnormal situation around the traveling path by analyzing the security information to transmit the determined abnormal situation to the security control apparatus 100 through the security control transceiver 330.

The traveling navigation unit 360 provides information on the traveling path for free traveling.

The robot attachment/detachment unit 370 is combined with or separated from the track security apparatus 200 so that the autonomous mobile robot apparatus 300 can travel along the track or freely travel alone.

The robot driving unit 380 drives the articulated motion unit 390 that performs an articulated motion depending on the control command of the security control apparatus 100.

The security control service system in accordance with the embodiment of the present invention whose elements are described with reference to FIGS. 1 to 4 may be established in a place that requires a high level of security such as a building, a factory, a laboratory, a military camp and the like.

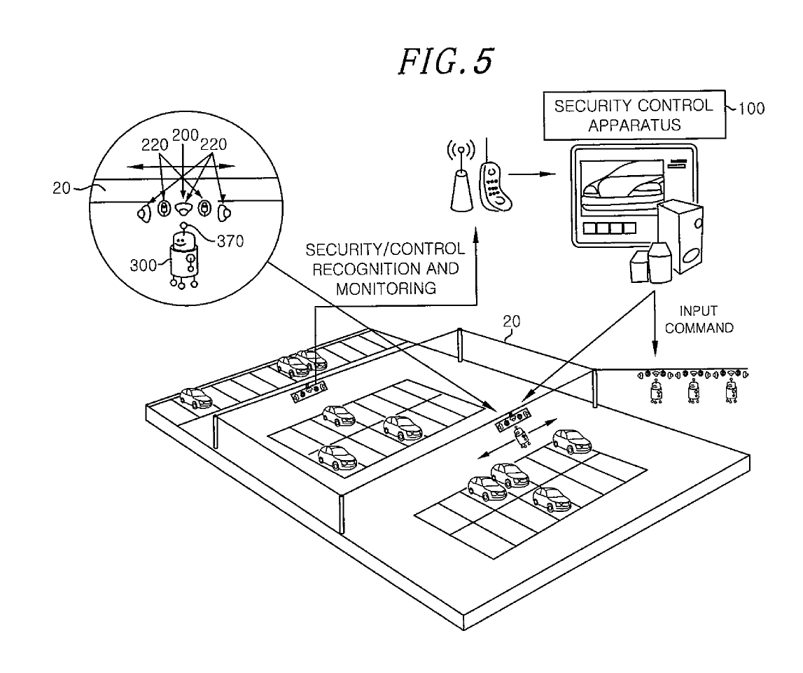

FIG. 5 is a conceptual view illustrating an example in which the security control service system is applied to a parking lot security control system, in accordance with the embodiment of the present invention.

First, the track 20 along which the track security apparatus 200 travels may be installed in a form of a rail, a cable or the like based on characteristics of the place to be secured. The path of the track 20 is designed to have maximum efficiency when the robot of the autonomous mobile robot apparatus 300 is put. The track of the rail, the cable or the like may be established in the shape of a circle as illustrated in FIG. 1 or may be established in the shape of a polygon having a linear section as shown in FIG. 5.

Herein, the track traveling unit 240 of the track security apparatus 200 to travel the track, the track or the like may adopt various designs and driving methods and adopts a method of investing minimum installation charges while being movable at a speed desired by the track security apparatus 200 depending on a place, climate, position, situation, and the like where it is to be installed. For example, when there is no wall or ceiling where a rail may be installed such as an outdoor parking lot or the like, a cable method is applied so that cable supporting bars are arranged at certain intervals and that the position, shape, number and the like of the supporting bars are assigned based on the weights and the installation and operation methods of the track security apparatus 200 and the autonomous mobile robot apparatus 300.

Also, in case of an indoor parking lot, the rail may be installed on the wall, the ceiling, or the bottom. In this case, the rail is installed so that the maximum control function can be performed by minimum installation. In addition, a power line for supplying a driving power to the track security apparatus 200 and the autonomous mobile robot apparatus 300 may be additionally installed when the track is installed. A wired transmission channel may be additionally installed in order to transmit the security information including the image and the voice or the like.

The track security apparatus 200 that travels along the track is mounted with one to four zoom/pan/tilt cameras and multiple microphones to provide security monitoring and recognition service. In case of the security control service system for security and monitoring at an airport parking lot, the track security apparatus 200 analyzes a photographed image while traveling the track to sense an abandoned bag, an abnormal object or the like to sense a dangerous material such as an explosive, to sense an action of forcibly opening a door or an abnormal action around a vehicle, or to sense and recognize a disaster such as fire or smoke, a situation in which many people gather or the like in real time and transmits the sensed dangerous or abnormal situation to the security control apparatus 100.

When the dangerous or abnormal situation is sensed and recognized by the track security apparatus 200, the security control apparatus 100 may combine the standby autonomous mobile robot apparatus 300 with the track security apparatus 200 to send the autonomous mobile robot apparatus 300 combined with the track security apparatus 200 to the position where the dangerous or abnormal situation is found. At this time, when the autonomous mobile robot apparatus 300 arrives at a desired position, the autonomous mobile robot apparatus 300 is separated from the track security apparatus 200 and the separated autonomous mobile robot apparatus 300 can freely travel to a specific position where the dangerous or abnormal situation is generated while receiving information on the traveling path from the traveling navigation unit 360 depending on the control command for remotely controlling the security control apparatus 100. The security information obtained through the security information acquisition unit 320 is transmitted to the security control apparatus 100 and the robot drive unit 380 drives the articulated motion unit 390 depending on the control command for remotely controlling the security control apparatus 100 so that various necessary first aids can be given and criminals can be arrested.

When it is not necessary to put the autonomous mobile robot apparatus 300 and only control for obtaining and transmitting the security information is necessary in a fixed position depending on a situation, the track security apparatus 200 is separated from the track by the track attachment/detachment unit 260 so that a peripheral situation can be monitored in the fixed position. In this case, when the situation is completed, the track security apparatus 200 can again enter the track by the track attachment/detachment unit 260 to travel along the track.

The security control apparatus 100 puts the standby track security apparatus 200 and the autonomous mobile robot apparatus 300 to the place to be secured through the track if it is necessary to provide security/abnormal information. At this time, the number of standby track security apparatuses 200 and autonomous mobile robot apparatuses 300 may be determined by estimating the purpose of the security control or necessary conditions, the maximum number of times of generation of simultaneous emergency situations in the installed place, or the like.

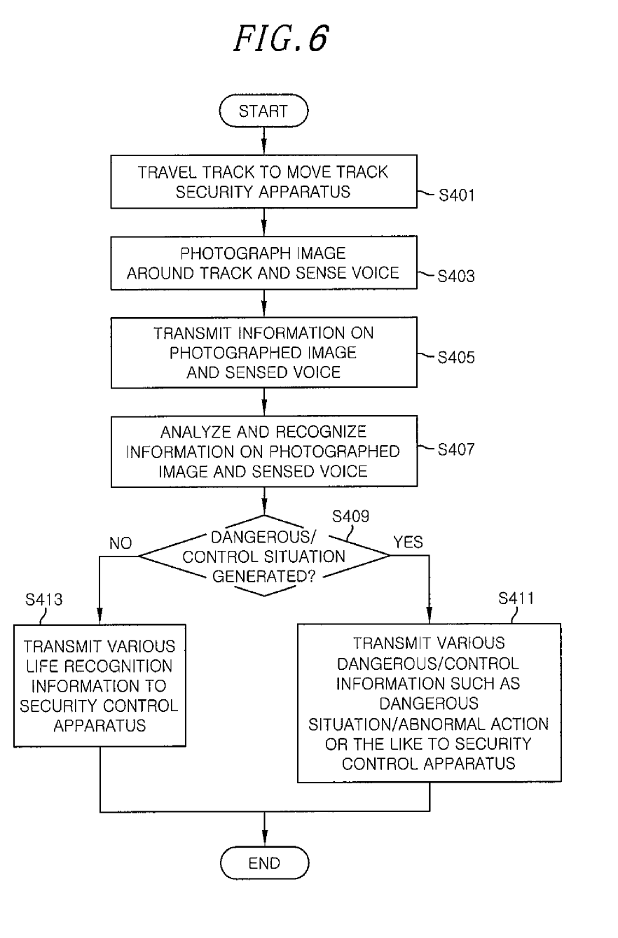

Hereinafter, a security control service process by the security control service system in accordance with the embodiment of the present invention will be described in time series with reference to FIGS. 6 to 8.

FIG. 6 illustrates a flowchart for explaining an operation process of the track security apparatus 200 in accordance with the embodiment of the present invention. First, the track security apparatus 200 moves while traveling the track 20 in step S401. Then, the track security apparatus 200 photographs a peripheral image of the track 20 and senses a voice to record it in step S403.

Thereafter, the track security apparatus 200 transmits the photographed image and voice information to the security control apparatus 100 in a wireless or wired method in step S405. Meanwhile, the track security apparatus 200 recognizes and analyzes the photographed image and the voice information in step S407 to determine whether a dangerous/abnormal situation is generated. When the dangerous/abnormal situation is determined to be generated in step S409, the track security apparatus 200 transmits various dangerous/abnormal (security) information presenting a dangerous situation/an abnormal action or the like to the security control apparatus 100 to alarm the abnormal situation or the like in step S411. When it is determined that the dangerous/abnormal situation is not generated in step S409, the track security apparatus 200 obtains various life recognition information such as recognition information on the license plate of a vehicle or the like to transmit the same to the security control apparatus 100 in step S413.

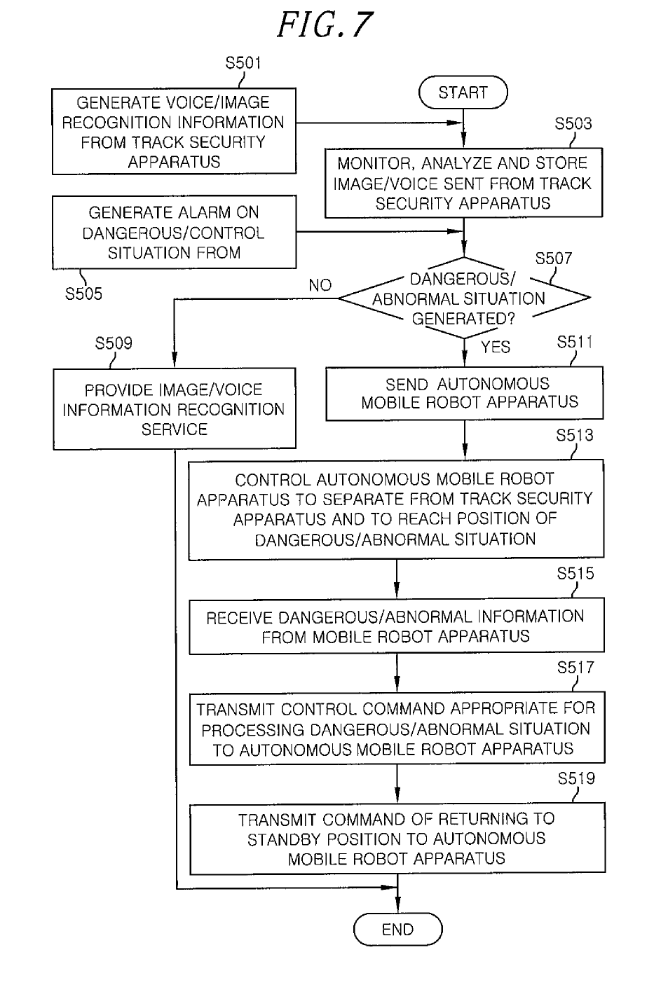

FIG. 7 shows a flowchart for explaining an operation process of the security control apparatus 100 in accordance with the embodiment of the present invention. Referring to FIG. 7, when the voice/image recognition information is generated and transmitted from the track security apparatus 200 in step S501, the security control apparatus 100 monitors the voice/image information sent by the track security apparatus 200 to store and analyze them in step S503 and determines whether a dangerous/abnormal situation is generated based on the analysis result in step S507. At this time, alarm information on the dangerous/abnormal situation may be also received from the track security apparatus 200 in step S505 to determine whether the dangerous/abnormal situation is generated.

When it is determined that the dangerous/abnormal situation is not generated in step S507, the security control apparatus 100 provides an information recognition service for outputting the obtained image/voice information through the security information output unit 160 in step S509. Meanwhile, when it is determined that the dangerous/abnormal situation is generated in step S509, the security control apparatus 100 controls the autonomous mobile robot apparatus 300 to combine with the track security apparatus 200 and moves (dispatch) the autonomous mobile robot apparatus 300 to the vicinity of the position where the dangerous/abnormal situation is generated through traveling along the track 20 in step S511.

When the autonomous mobile robot apparatus 300 travels around a position of the dangerous/abnormal situation, the security control apparatus 100 controls the autonomous mobile robot apparatus 300 to separate from the track security apparatus 200 and to reach the position of the dangerous/abnormal situation in step S513.

When the autonomous mobile robot apparatus 300 reaches the location of the dangerous/abnormal location, the security control apparatus receives the dangerous/abnormal information (images, voices and the like) from the autonomous mobile robot apparatus 300 in step S515.

After receiving the dangerous/abnormal information from the autonomous mobile robot apparatus 300, the security control apparatus 100 transmits a control command appropriate for processing the dangerous/abnormal situation to the autonomous mobile robot apparatus 300 in step S517.

When the security control apparatus 100 receives a process completion message from the autonomous mobile robot apparatus 300, the security control apparatus 100 transmits a command of returning to a standby position to the autonomous mobile robot apparatus 300 in step S519.

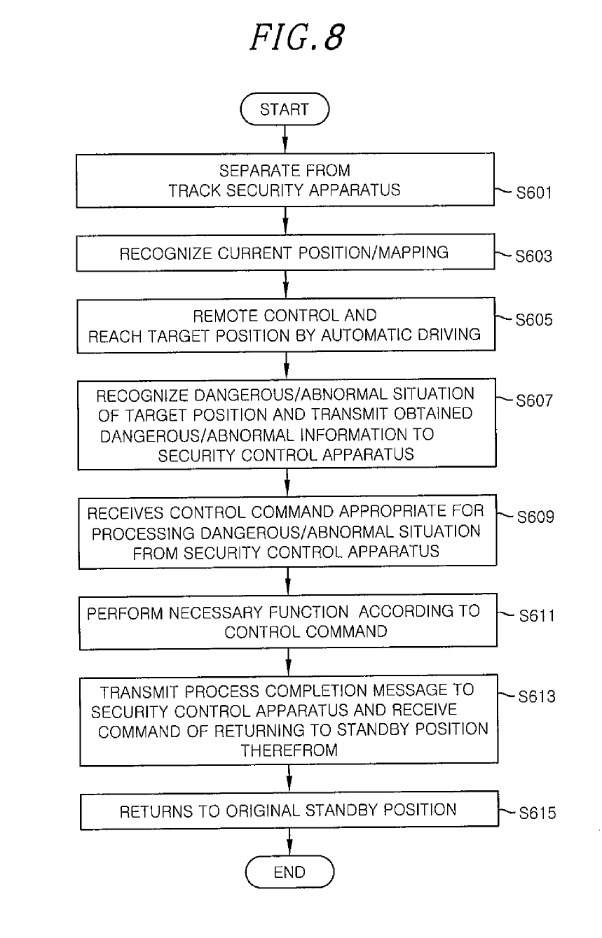

FIG. 8 illustrates a flowchart for explaining an operation process of the autonomous mobile robot apparatus 300 in accordance with an embodiment of the present invention. Referring to FIG. 8, the autonomous mobile robot apparatus 300 is separated from the track security apparatus 200 after reaching the vicinity of the position where the dangerous/abnormal situation is generated in step S601. Then, the autonomous mobile robot apparatus 300 recognize its current position by the traveling navigation unit 360 and performs mapping in step S603. Thereafter, the autonomous mobile robot apparatus 300 freely travels depending on the remote control command of the security control apparatus 100 to arrive at a target position in step S605.

After arriving at the target position, the autonomous mobile robot apparatus 300 recognizes a dangerous/abnormal situation of the target position and transmits obtained dangerous/abnormal information to the security control apparatus 100 in step S607.

Then, the autonomous mobile robot apparatus 300 receives a control command appropriate for processing the dangerous/abnormal situation from the security control apparatus 100 in step S609.

Then, the robot driving unit 380 drives the articulated motion unit 390 depending on the control command of the security control apparatus 100 to perform the necessary functions of monitoring, reconnaissance, arrest, emergency situation repress, rescue, repair or the like in step S611.

Then, the robot driving unit 380 transmits a process completion message to the security control apparatus 100 and receives a command of returning to an original standby position from the security control apparatus 100 in step S613.

Thereafter, the autonomous mobile robot apparatus 300 returns to the place where the track security apparatus 200 is placed and is combined with the track security apparatus 200 to return to the original standby position in step S615.

The security control service method in accordance with the embodiment of the present invention as described above may be implemented with a computer program. Codes and code segments constituting the computer program may be easily inferred by a computer programmer in the art. Further, the computer program may be stored in a computer-readable storage medium, and read and executed by a computer, the security control apparatus, the track control apparatus, the autonomous mobile robot apparatus, or the like in accordance with the embodiments of the present invention, thereby implementing the security control service method. The computer-readable storage medium includes a magnetic recording medium, an optical recording medium, and a carrier wave medium.

In accordance with the embodiment of the present invention, the autonomous mobile robot apparatus can perform the security control function on a wide region while freely moving the wide region regardless of the situations of the traveling road where stairs or obstacles exist, or the like.

In the security control service system in accordance with the embodiment of the present invention, various application services can be utilized through image and voice recognition information transmitted by the track security apparatus together with the dangerous/abnormal situation security control service. For example, when the recognition of the security information using a pan/tilt/zoom camera and microphone connected to the track security apparatus is applied to the parking lot control service, the position of a vehicle that is parked or is being parked in the parking lot and an empty parking space are updated in real time to guide the vehicles that enter and leave the parking lot to an optimum empty parking space or to provide vehicle position information on the vehicle parked in a large scale parking lot.

In addition, when the track security apparatus is installed in a warehouse, the track security apparatus grasps whether the abnormal situation is generated while traveling the track as a person recognizes whether the abnormal situation is generated while patrolling and dispatch the autonomous mobile robot apparatus if necessary to recognize a correct situation. As another application, when the security control service system is installed in the corridor of a school or a dead zone, various situations such as trouble between students, invasion of an outsider or the like that is generated at the school can be sensed/alarmed in real time.

Moreover, when the security control service system in accordance with the embodiment of the present invention is used, many crime prevention CCTV cameras installed at roads, airports or the like can be replaced, thereby establishing a more inexpensive and effective crime prevention system.

While the invention has been shown and described with respect to the particular embodiments, it will be understood by those skilled in the art that various changes and modification may be made without departing from the scope of the invention as defined in the following claims.

What is claimed is:

1. A security control apparatus, comprising:
a control command input unit for receiving a control command on a place to be secured;
a security information transceiver for transmitting a control command for security control or receiving security information including a peripheral image and a voice through communication with a track security apparatus that obtains the security information while traveling along a track installed in the place to be secured or through communication with an autonomous mobile robot apparatus which obtains the security information including a peripheral image and a voice to transmit the security information while traveling along the track in a state that the autonomous mobile robot apparatus is combined with the track security apparatus or while freely traveling in the place to be secured in a state that the autonomous mobile robot apparatus is separated from the track security apparatus;
a security information storage unit for storing the received security information;
a security information analysis unit for analyzing the received security information to determine an abnormal situation of the place to be secured, and generating the control command to be transmitted to the track security apparatus or the autonomous mobile robot apparatus through the security information transceiver for combining or separating the autonomous mobile robot apparatus with or from the track security apparatus based on a result of determining the abnormal situation or for performing necessary functions of monitoring, reconnaissance, arrest, emergency situation repress, rescue or repair by the autonomous mobile robot apparatus which has been approached a target position where an abnormal situation occurs; and
a security information output unit for outputting information on the determined abnormal situation of the place to be secured.

2. The security control apparatus of claim 1, further comprising:
a power supply unit for supplying a driving power to the track security apparatus or the autonomous mobile robot apparatus through a power line installed along the path of the track.

3. A track security apparatus comprising:
a track traveling unit for traveling along a track installed in a place to be secured;
a security information acquisition unit for obtaining security information including a peripheral image and a voice depending on traveling of the track traveling unit;
a security control transceiver for receiving a control command from a security control apparatus which transmits the control command depending on an input control command for security control or transmitting the security information to the security control apparatus;
a security information analysis unit for determining a peripheral abnormal situation of the track by analyzing the security information to transmit the determined abnormal situation to the security control apparatus through the security control transceiver; and
a robot attachment/detachment unit combined with or separated from an autonomous mobile robot apparatus depending on the control command information to make the autonomous mobile robot apparatus travel along the track with the track security apparatus or freely travel alone in the place to be secured and obtain the security information including a peripheral image and a voice to determine a peripheral abnormal situation of a traveling position by analyzing the obtained security.

4. The track security apparatus of claim 3, further comprising:
a power source unit for receiving a driving power supplied from the security control apparatus supplied through a power line installed along the path of the track.

5. The track security apparatus of claim 3, further comprising:
a track attachment/detachment unit combined with or separated from the track so that the track security apparatus can travel along the track or is positioned around the track.

6. An autonomous mobile robot apparatus, comprising:
a free traveling unit for freely traveling separately from a track installed in a place to be secured;
a robot attachment/detachment unit combined with or separated from a track security apparatus, which obtains security information including a peripheral image and a voice while traveling along the track, so that the autonomous mobile robot apparatus can travel along the track with the track security apparatus or freely travel alone the place to be secured;
a traveling navigation unit for providing information on a traveling path for the free traveling;
a security information acquisition unit for obtaining security information including a peripheral image and a voice during the free traveling;
a security control transceiver for receiving a control command from a security control apparatus which transmits the control command depending on an input control command for security control or transmitting the security information to the security control apparatus; and
a security information analysis unit for determining a peripheral abnormal situation of the traveling path by analyzing the security information so that the determined abnormal situation is transmitted to the security control apparatus through the security control transceiver.

7. The autonomous mobile robot apparatus of claim 6, further comprising:
an articulated motion unit for performing an articulated motion; and
a robot driving unit for driving the articulated motion unit depending on the control command.

8. The autonomous mobile robot apparatus of claim 6, further comprising:
a power source unit for receiving a power supplied from the security control apparatus through a power line installed along the path of the track or receiving power supplied from the track security apparatus to perform charging and to provide a driving power through discharging.

9. A security control service system, comprising:
a track security apparatus for traveling along a track installed in a place to be secured, obtaining and transmitting to a security control apparatus security information including a peripheral image and a voice around the track, and detecting a peripheral abnormal situation of the track by analyzing the obtained security information and transmitting the determined abnormal situation to the security control apparatus;
an autonomous mobile robot apparatus for traveling along the track together with the track security apparatus in a state that the autonomous mobile robot apparatus is combined with the track security apparatus and freely traveling in the place to be secured in a state that the autonomous mobile robot apparatus is separated from the track security apparatus, obtaining and transmitting to the security control apparatus security information including a peripheral image and a voice around a traveling path, and detecting a peripheral abnormal situation of a traveling position by analyzing the obtained security information and transmitting the detected abnormal situation to the security control apparatus; and
the security control apparatus for receiving the security information and information on the detected abnormal situation of the track from the track security apparatus or receiving the security information and information on the detected abnormal situation of the traveling position from the autonomous mobile robot apparatus, analyzing the security information received from the track security apparatus or the autonomous mobile robot apparatus to determine an abnormal situation of the track or the traveling position of the autonomous mobile robot apparatus, outputting information on the abnormal situation of the track or the traveling position of the autonomous mobile robot apparatus, and transmitting a control command for security control to the track security apparatus or the autonomous mobile robot apparatus depending on the abnormal situation around the track or around the traveling, or depending on an input control command.

10. The security control service system of claim 9, wherein the autonomous mobile robot apparatus is separated from the track security apparatus to freely travel to a specific position within the place to be secured and perform a necessary function of monitoring, reconnaissance, arrest, emergency situation repress, rescue or repair through an articulated motion depending on the control command.

11. A security control service method by a security control service system, comprising:
obtaining security information including peripheral image and voice while a track security apparatus travels along a track installed in a place to be secured;
analyzing, at a security control apparatus that has received the security information, the security information to determine an abnormal situation of the place to be secured;
generating, at the security control apparatus, a control command for security control depending on an abnormal situation of the place to be secured or an input control command;
allowing an autonomous mobile robot apparatus to be combined with the track security apparatus to travel along the track, depending on the control command;
allowing the autonomous mobile robot apparatus to be separated from the track security apparatus depending on the control command so that the autonomous mobile robot apparatus freely travels to a specific position within the place to be secured; and
obtaining, at the autonomous mobile robot apparatus, the security information including image and voice around the specific position and transmitting the security information to the security control apparatus, depending on the control command.

12. The security control service method of claim 11, further comprising:
receiving information on the abnormal situation at the security control apparatus from the track security apparatus or the autonomous mobile robot apparatus; and
generating, at the security control apparatus, the control command depending on the received information on the abnormal situation, and transmitting the generated control command to the track security apparatus or the autonomous mobile robot apparatus.

13. The security control service method of claim 11, further comprising:
allowing the track security apparatus to be separated from the track and positioned around the track depending on the control command.

14. The security control service method of claim 11, further comprising:
allowing the autonomous mobile robot apparatus to perform a necessary function of monitoring, reconnaissance, arrest, emergency situation repress, rescue or repair through an articulated motion at the specific position depending on the control command.
